(19) United States
(12) Patent Application Publication
(10) Pub. No.: US 2025/0190862 A1
(43) Pub. Date: Jun. 12, 2025

(54) CONTROL APPARATUS, MODEL LEARNING APPARATUS, SECURE FEDERATED LEARNING APPARATUS, THEIR METHODS, AND PROGRAMS

(71) Applicant: NIPPON TELEGRAPH AND TELEPHONE CORPORATION, Tokyo (JP)

(72) Inventors: Iifan TYOU, Tokyo (JP); Gembu MOROHASHI, Tokyo (JP); Takumi FUKAMI, Tokyo (JP)

(73) Assignee: NIPPON TELEGRAPH AND TELEPHONE CORPORATION, Tokyo (JP)

(21) Appl. No.: 18/842,038

(22) PCT Filed: Mar. 31, 2022
(86) PCT No.: PCT/JP2022/016504

§ 371 Date: Aug. 27, 2024

(51) Int. Cl. G06N 20/00

(52) U.S. Cl. CPC G06N 20/00

(57) ABSTRACT

A federated learning system including a model learning device and a secure federated learning device is controlled. The model learning device updates an aggregate model by machine learning using local learning data to obtain information for identifying a worker model and executes local processing for providing confidential information of the information for identifying the worker model to the secure federated learning device. The secure federated learning device obtains confidential information of information for identifying a new aggregate model obtained by aggregating a plurality of worker models through secure computation using the obtained confidential information of the information for identifying the worker model without obtaining the worker models, and executes secure aggregation processing for providing the information for identifying the new aggregate model or the confidential information of the information for identifying the new aggregate model to a plurality of model learning devices. In this case, asynchronous control for causing local processing of the plurality of model learning devices to be executed asynchronously is performed in a case in which a local processing time corresponding to the local processing is longer than an aggregation processing time corresponding to the secure aggregation processing, and synchronous control for synchronizing the local processing of the plurality of model learning devices is performed in a case in which the asynchronous control is not performed.

### TECHNICAL FIELD

The present invention relates to machine learning technology, and particularly, to a federated learning technology.

### BACKGROUND ART

Federated learning in which machine learning is performed in a state in which learning data is distributed without being aggregated is known (refer to NPL 1 and the like, for example). In federated learning, a plurality of model learning devices perform machine learning using learning data held thereby to generate worker models (local models) and transmit the generated worker models to a federated learning device. The federated learning device generates an aggregate model (a global model) obtained by aggregating the worker models sent from the plurality of model learning devices and transmits the generated aggregate model to the plurality of model learning devices. The plurality of model learning devices that have received the aggregate model update the aggregate model by machine learning using learning data held thereby to generate a new worker model and transmit the generated worker model to the federated learning device. By repeating such processing, each model learning device can obtain an aggregate model in which learning data held in the plurality of model learning devices has been reflected in machine learning without passing learning data held by itself to the outside.

### CITATION LIST

### Non Patent Literature

[NPL 1]C. He, S. Li, J. So, X. Zeng, M. Zhang, etc., “FedML: A Research Library and Benchmark for Federated Machine Learning,” [online], Jan. 27, 2020, arXiv: 2007.13518, [retrieved on Feb. 17, 2022], Internet <https://arxiv. org/abs/2007.13518>

### SUMMARY OF INVENTION

### Technical Problem

However, in the conventional federated learning, the federated learning device receives a plaintext worker model from each model learning device. Therefore, the federated learning device can ascertain the tendency of learning data held by each model learning device on the basis of differences between the transmitted aggregate model and received worker models. Further, in the conventional federated learning, the processing speed of each model learning device is not considered, and thus the efficiency is low.

In view of the aforementioned circumstances, an object of the present invention is to improve the safety and efficiency of federated learning.

### Solution to Problem

A control device controls a federated learning system including a plurality of model learning devices and a single or a plurality of secure federated learning devices. Here, the model learning devices execute local processing for updating an aggregate model through machine learning using local learning data to obtain information for identifying worker models and providing confidential information of information for identifying the worker models to the secure federated learning device. Further, the secure federated learning device executes secure aggregation processing for obtaining confidential information of information for identifying a new aggregate model obtained by aggregating the plurality of worker models through secure computation using the obtained confidential information of the information for identifying the worker models without obtaining the worker models, and providing the information for identifying the new aggregate model or confidential information of the information for identifying the new aggregate model to the plurality of model learning devices. The control device compares a local processing time corresponding to the local processing with an aggregation processing time corresponding to the secure aggregation processing, performs asynchronous control for causing the local processing of the plurality of model learning devices to be executed asynchronously in a case in which the local processing time is longer than the aggregation processing time or the local processing time is equal to or longer than the aggregation processing time, and performs synchronous control for synchronizing the local processing of the plurality of model learning devices in a case in which the asynchronous control is not performed.

### Advantageous Effects of Invention

Accordingly, the safety and efficiency of federated learning can be improved.

### BRIEF DESCRIPTION OF DRAWINGS

FIG. 1 is a block diagram showing a configuration example of a federated learning system of an embodiment.

FIG. 2 is a block diagram illustrating a configuration of a model learning device of an embodiment.

FIG. 3 is a block diagram illustrating a configuration of a secure federated learning device of an embodiment.

FIG. 4 is a block diagram illustrating a configuration of a control device of an embodiment.

FIG. 5 is a flowchart for describing a control method of an embodiment.

FIG. 6 is a block diagram illustrating a hardware configuration of an embodiment.

### DESCRIPTION OF EMBODIMENTS

An embodiment of the present invention will be described below with reference to the drawings.

### First Embodiment

The present embodiment illustrates a form in which a federated learning system including a plurality of model learning devices and a single or a plurality of secure federated learning devices is controlled by a control device provided separately from the secure federated learning devices.

### <Configuration>

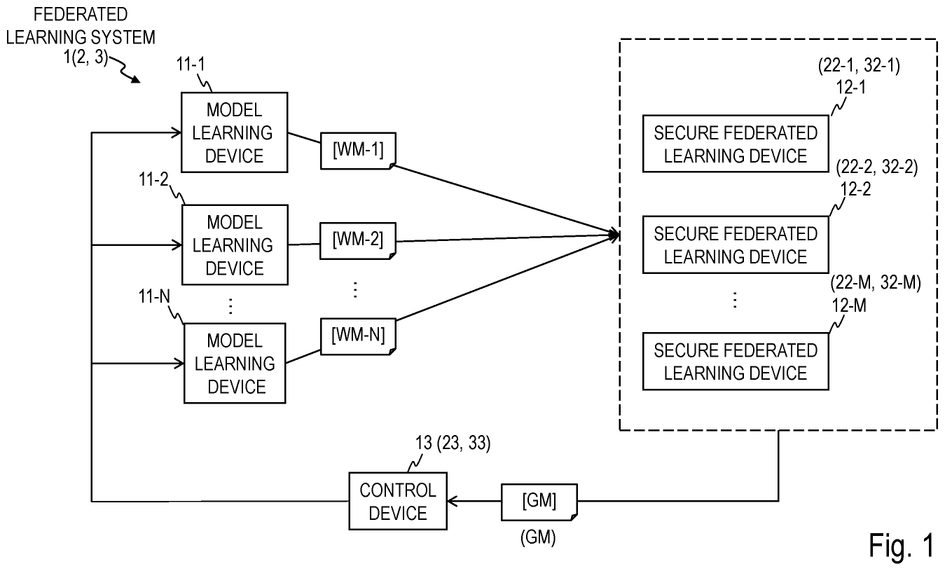

As illustrated in FIG. 1, the federated learning system 1 of the present embodiment includes N model learning devices 11-1, . . . , 11-N for performing model learning, M secure federated learning devices 12-1, . . . , 12-M for performing federated learning by secure computation, and a control device 13 for controlling the federated learning system 1. The secure computation method is not limited. For example, the secure computation method may be a multiparty computation method for performing secure computation using securely distributed shares or a homomorphic encryption method for performing secure computation using homomorphic encryption. N is any integer of 2 or more. M is an integer of 1 or more and, for example, M is an integer of 2 or more. However, in a case in which the secure computation method is the multiparty computation method, M is an integer of 2 or more. In a case in which the secure computation method is the homomorphic encryption method, M is an integer of 1 or more, for example, M=1.

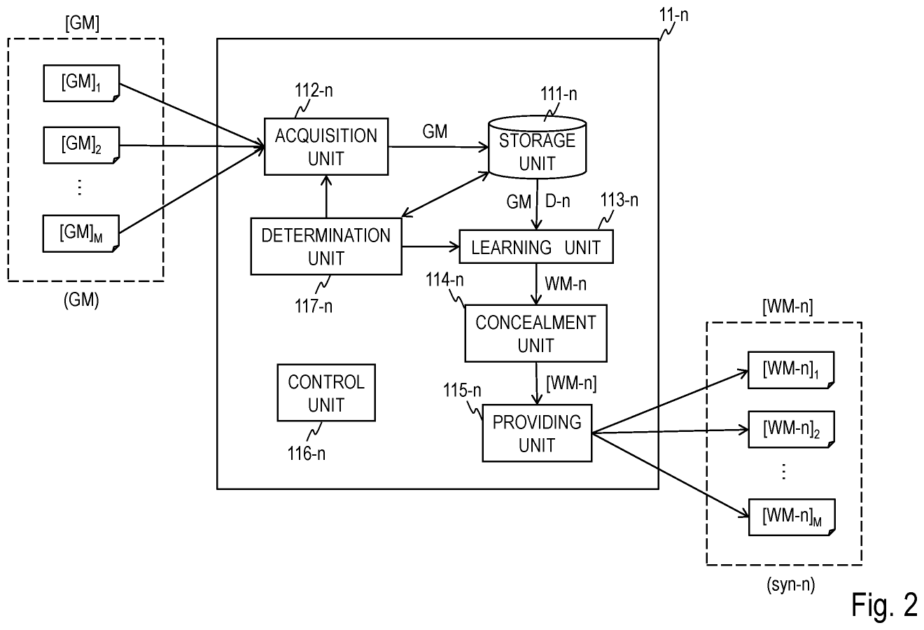

As illustrated in FIG. 2, the model learning device 11-n of the present embodiment includes a storage unit 111-n, an acquisition unit 112-n, a learning unit 113-n, a concealment unit 114-n, a providing unit 115-n, a control unit 116-n, and a determination unit 117-n. The model learning device 11-n executes each kind of processing on the basis of the control of the control unit 116-n, and input information and information acquired through each kind of processing are stored in the storage unit 111-n, and read and used as necessary. Here, n is a positive integer and n=1, . . . , N. Unless otherwise specified, configurations and processing with respect to n are the same for all of n=1, . . . , N. However, details of data (information) to be handled may vary depending on the value of n.

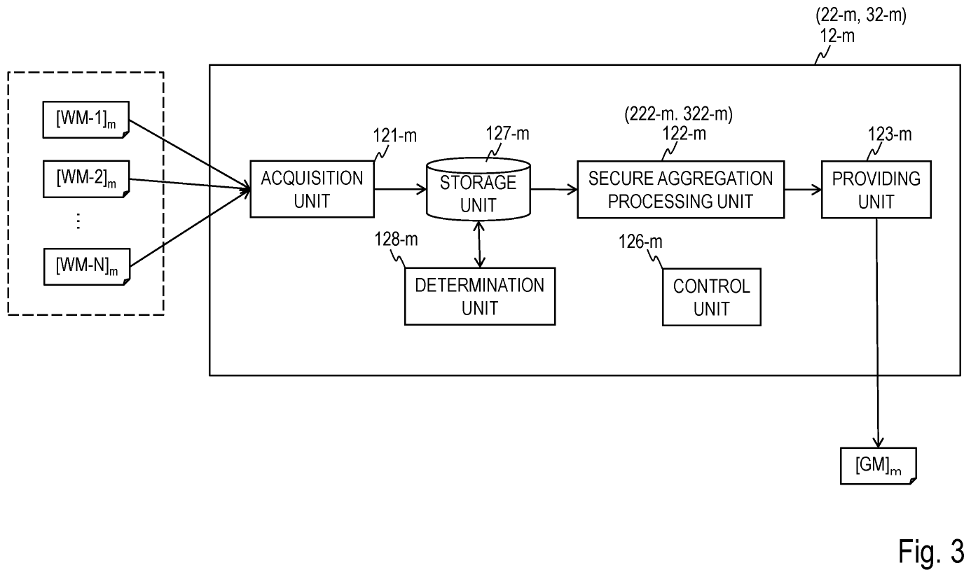

As illustrated in FIG. 3, the secure federated learning device 12-m of the present embodiment includes an acquisition unit 121-m, a secure aggregation processing unit 122-m, a providing unit 123-m, a control unit 126-m, a storage unit 127-m, and a determination unit 128-m. The secure federated learning device 12-m executes each kind of processing on the basis of the control of the control unit 126-m, and input information and information acquired through each kind of processing are stored in the storage unit 127-m, and read and used as necessary. Here, m is a positive integer and m=1, . . . , M. Unless otherwise specified, configurations and processing with respect to m are the same for all of m=1, . . . , M. However, details of data (information) to be handled may vary depending on the value of m.

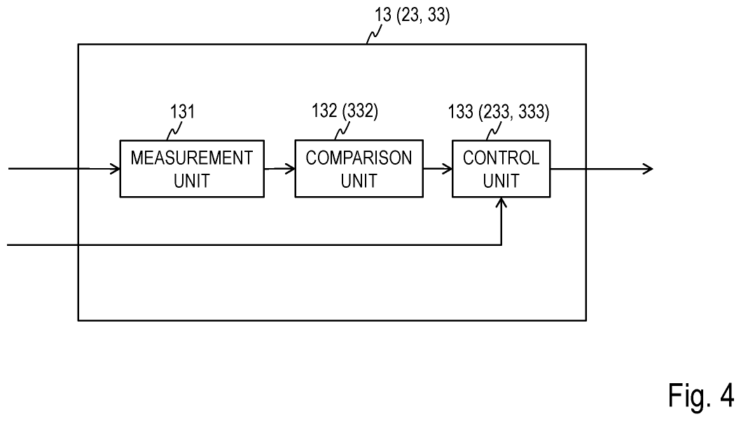

As illustrated in FIG. 4, the control device 13 of the present embodiment includes a measurement unit 131, a comparison unit 132, and a control unit 133.

### <Preprocessing>

Local learning data D-n of each model learning device 11-n is stored in the storage unit 111-n of the model learning device 11-n. The local learning data D-n is learning data for machine learning and may be learning data for supervised learning or learning data for unsupervised learning. Further, the local learning data D-n may be updated. Further, in a case in which a secure computation method to be used is the homomorphic encryption method, an encryption key and a decryption key are stored in the storage unit 111-n of the model learning device 11-n.

### <Learning Processing>

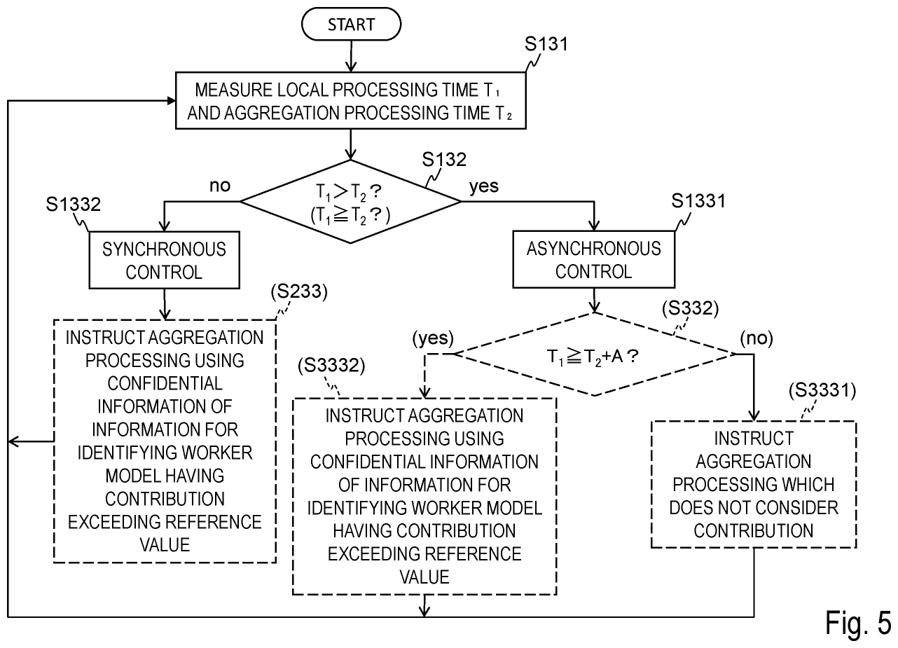

Learning processing of the present embodiment will be described using FIG. 5. Each model learning device 11-n (where n=1, . . . , N) (FIG. 1) executes local processing for updating an aggregate model by machine learning using the local learning data D-n to obtain information WM-n (for example, a model parameter group) for identifying worker models and providing confidential information [WM-n] of the information WM-n for identifying worker models to the secure federated learning device 12-m (where m=1, . . . , M).

Each secure federated learning device 12-m (where m=1, . . . , M) executes secure aggregation processing for obtaining confidential information [GM]ₘ of information GM for identifying a new aggregate model obtained by aggregating a plurality of worker models through secure computation using the confidential information [WM-n]for identifying the obtained worker model without obtaining the worker model, and providing the confidential information [GM]ₘ of the information GM for identifying the new aggregate model to the plurality of model learning devices 11-n.

Such local processing and secure aggregation processing are alternately repeated until predetermined end conditions (for example, conditions that a number of updates, an update amount, an update time, and the like of an aggregate model have reached prescribed values) are satisfied. In this case, a new aggregate model corresponding to the confidential information [GM]ₘ obtained through secure aggregation processing is used as an aggregate model in the next local processing. Here, each secure federated learning device 12-m cannot obtain a worker model itself and thus cannot ascertain the tendency of the local learning data D-n held by each model learning device 11-n on the basis of differences between worker models and the aggregate model. Accordingly, the safety of federated learning can be improved.

The measurement unit 131 (FIG. 4) of the control device 13 measures a local processing time T₁ corresponding to local processing and an aggregation processing time T₂ corresponding to secure aggregation processing in the federated learning system 1. For example, the local processing time T₁ is a time required to perform local processing once, and the aggregation processing time T₂ is a time required to perform secure aggregation processing once. Alternatively, the local processing time T₁ may be a total time for which local processing has been performed in a time required to perform local processing B times, and the aggregation processing time T₂ may be a total time for which secure aggregation processing has been performed in a time required to perform secure aggregation processing B times. Here, B is an integer of 2 or more. Alternatively, the local processing time T₁ may be an average time required to perform local processing once, and the aggregation processing time T₂ may be an average time required to perform secure aggregation processing once. For example, one instance of local processing involves all of N model learning devices 11-1, . . . , 11-N executing local processing, and one instance of secure aggregation processing involves all of M secure federated learning devices 12-1, . . . , 12-M executing secure aggregation processing. Alternatively, for example, one instance of local processing may involve C % or more of the N model learning devices 11-1, . . . , 11-N executing local processing, and one instance of secure aggregation processing may involve C % or more of the M secure federated learning devices 12-1, . . . , 12-M executing local processing. Here, C is a real number satisfying 0≤C≤100).

Alternatively, for example, one instance of local processing may involve one model learning device 11-n executing local processing, and one instance of secure aggregation processing may involve one secure federated learning device 12-m executing local processing. The measured local processing time T₁ and aggregation processing time T₂ are sent to the comparison unit 132 (step S131).

The comparison unit 132 compares the sent local processing time T₁ with the aggregation processing time T₂ (step S132) Here, if the local processing time T₁ is longer than the aggregation processing time T₂ (T1>T2) or the local processing time T₁ is equal to or longer than the aggregation processing time T₂ (T1≥T2), the control unit 133 performs asynchronous control for causing the plurality of model learning devices 11-1, . . . , 11-N to execute local processing asynchronously. Thereafter, processing returns to step S131. In a case in which T₁>T₂ or T₁≥T₂, there is a time margin on the side of the secure federated learning devices 12-1, . . . , 12-M as compared with the model learning devices 11-1, . . . , 11-N. In such a case, a case in which the model learning devices 11-1, . . . , 11-N execute local processing asynchronously, and before local processing of all the model learning devices 11-1, . . . , 11-N is finished, the secure federated learning devices 12-1, . . . , 12-M execute secure aggregation processing may be more efficient (step S1331). On the other hand, in a case in which asynchronous control is not performed (that is, in a case in which the local processing time T₁ is equal to or less than the aggregation processing time T₂ or the local processing time T₁ is longer than the aggregation processing time T₂), the control unit 133 performs synchronous control for synchronizing local processing of the plurality of model learning devices 11-1, . . . , 11-N. Thereafter, processing returns to step S131. In a case in which T₁<T₂ or T₁<T₂, there is a time margin on the side of the model learning devices 11-1, . . . , 11-N as compared with the secure federated learning devices 12-1, . . . , 12-M. In such a case, a case in which local processing of the model learning devices 11-1, . . . , 11-N are synchronized and the secure aggregation processing of the secure federated learning devices 12-1, . . . , 12-M is executed on the basis of the processing results may be more efficient (step S1332).

### [One Example of Synchronous Control (Step S1332)]

Processing of the federated learning system 1 through synchronous control is illustrated. Note that synchronous control below is an example and does not restrict the present invention.

In synchronous control, each model learning device 11-n executes local processing in synchronization with local processing of other model learning devices 11-n′ (where n and n′∈{1, . . . , N}) included in the federated learning system 1. That is, the plurality of model learning devices 11-1, . . . , 11-N execute mutually synchronized local processing. In a case in which synchronous control is performed, the control unit 133 instructs each model learning device 11-n (FIG. 2) to execute local processing through synchronous control. This instruction is acquired by the acquisition unit 112-n and sent to the control unit 116-n. The control unit 116-n executes synchronous control. The learning unit 113-n reads local learning data D-n stored in the storage unit 111-n, updates the latest aggregate model by machine learning using the local learning data D-n to obtain a worker model, and outputs information WM-n (for example, a model parameter group) for identifying the worker model. In a case in which the model learning device 11-n has not yet obtained an aggregate model, an initially set machine learning model is the “latest aggregate model.” An initially set machine learning model may be provided from the control device 13. An initially set model is, for example, a machine learning model in which an initial model parameter group is set. In a case in which the model learning device 11-n obtains information GM for identifying an aggregate model as will be described later, the latest one of aggregate models identified by the information GM is the “latest aggregate model.” In the latter case, the learning unit 113-n identifies the latest aggregate model on the basis of information GM read from the storage unit 111-n. Note that an aggregate model and a worker model are known machine learning models. The present invention is not limited to an aggregate model and a worker model, and models may be models based on a deep learning method, models based on a hidden Markov model method, models based on a support vector machine method, or models based on linear prediction. However, all aggregate models and worker models handled by the federated learning system 1 are models based on the same method. The information WM-n for identifying worker models is sent to the concealment unit 114-n (step S113-n).

The information WM-n for identifying worker models is input to the concealment unit 114-n. The concealment unit 114-n conceals the information WM-n for identifying worker models in a manner in which the above-described secure computation can be performed to obtain confidential information [WM-n] of the information WM-n for identifying worker models and outputs the confidential information [WM-n]. For example, in a case in which the above-described secure computation method is multiparty computation, the concealment unit 114-n securely distributes the information WM-n to M pieces of information to obtain M shares [Wm-n]₁, . . . , [WM-n]_{M} and outputs these shares as confidential information [WM-n]. For example, in a case in which the above-described secure computation method is the homomorphic encryption method, the concealment unit 114-n encrypts the information WM-n according to the homomorphic encryption method using an encryption key read from the storage unit 111-n to obtain M (for example, one) pieces of ciphertext [WM-n]₁, . . . , [WM-n]_{M} and outputs the ciphertext [WM-n]₁, . . . , [WM-n]_{M} as confidential information [WM-n]. The confidential information [WM-n]={[WM-n]₁, . . . , [WM-n]_{M}} is sent to the providing unit 115-n (step S114-n).

The confidential information [WM-n]={[WM-n]₁, . . . , [WM-n]_{M}} of the information WM-n for identifying worker models is input to the providing unit 115-n. The providing unit 115-n transmits (provides) confidential information [WM-n]m of the information WM-n for identifying the corresponding worker model to the secure federated learning device 12-m (FIG. 3) (where m=1, M). Further, the providing unit 115-n sends synchronization information indicating the effect that the model learning device 11-n has transmitted the confidential information [WM-n]ₘ to the secure federated learning device 12-m (the effect that the model learning device 11-n has finished learning of a worker model and transmitted the confidential information [WM-n]ₘ of the information WM-n for identifying the worker model to the secure federated learning device 12-m) to the control device 13 (step S115-n).

The acquisition unit 121-m of the secure federated learning device 12-m (FIG. 3) receives the confidential information [WM-n]ₘ of the information WM-n for identifying the worker model sent from the model learning device 11-n and stores the confidential information [WM-n]ₘ in the storage unit 127-m. That is, the acquisition unit 121-m obtains confidential information [WM-n]ₘ of information WM-n for identifying a plurality of worker models from the plurality of model learning devices 11-n and stores the confidential information in the storage unit 127-m (step S121-m).

The control unit 133 of the control device 13 determines whether or not all the model learning devices 11-1, . . . , 11-N have transmitted the confidential information [WM-n]₁, . . . , [WM-n]_{M} to all the secure federated learning devices 12-1, . . . , 12-M on the basis of the synchronization information (step S1332a). Here, in a case in which it is determined that not all the model learning devices 11-n (where n=1, . . . , N) have transmitted the confidential information [WM-n]₁, . . . , [WM-n]_{M} to all the secure federated learning devices 12-1, . . . , 12-M, and a predetermined time has not elapsed from a reference point in time (time-out has not occurred), the control unit 133 performs determination of step S1332a at every certain interval. On the other hand, in a case in which it is determined that all the model learning devices 11-n (where n=1, . . . , N) have transmitted the confidential information [WM-n]₁, . . . , [WM-n]_{M} to all the secure federated learning devices 12-1, . . . , 12-M, or the predetermined time has elapsed from the reference point in time (time-out has occurred), the control unit 133 sends an instruction to start secure aggregation processing to the secure federated learning devices 12-1, . . . , 12-M. Note that the aforementioned reference point in time of time-out may be any point in time, for example, a start time or an end time of previous secure aggregation processing may be used as the reference point in time, or a start time of learning processing may be used as the reference point in time if secure aggregation processing is not yet executed (S1332b).

The instruction to start secure aggregation processing is received by the acquisition unit 121-m of the secure federated learning device 12-m (where m=1, . . . , M) (FIG. 3), and input to the control unit 126-m. The control unit 126-m that has received the instruction to start secure aggregation processing instructs the secure aggregation processing unit 122-m to start secure aggregation processing. The secure aggregation processing unit 122-m that has received the instruction reads a plurality of pieces of confidential information [WM-n](where, n∈{1, . . . , N}) (confidential information of information for identifying a plurality of worker models) from the storage unit 127-m, obtains confidential information [GM]ₘ of information GM for identifying an aggregate model obtained by aggregating the plurality of worker models, and outputs the aggregate model through secure computation using the confidential information [WM-n]without obtaining the plurality of worker models. For example, in a case in which information WM-n for identifying a worker model is a model parameter group {p₁(n), . . . , p_{K}(n)} of the worker model, a model parameter group {p₁, . . . , pₖ}obtained by aggregating a model parameter group {p₁(n₁), . . . , p_{K}(n₁)}, . . . , {p₁(nₘₐₓ), . . . , p_{K}(nₘₐₓ)} with respect to {n₁, . . . , nₘₐₓ}⊆{1, . . . , N}becomes information GM for identifying an aggregate model. For example, pₖ is a function value such as a weighted linear combination value or an average value of pₖ(n₁), . . . , pₖ(nₘₐₓ). Here, k is an index k=1, . . . , K for identifying a model parameter, and K is a positive integer. The secure aggregation processing unit 122-m obtains and outputs the confidential information [GM]ₘ of the information GM for identifying the aggregate model through secure computation without restoring such information WM-n for identifying the worker model and information GM for identifying the aggregate model. The confidential information [GM]ₘ of the information GM for identifying the aggregate model is sent to the providing unit 123-m (step S122-m).

The confidential information [GM]ₘ is input to the providing unit 123-m. The providing unit 123-m transmits (provides) the confidential information [GM]ₘ to the plurality of model learning devices 11-n (where n∈{1, . . . , N}) via the control device 13. For example, the providing unit 123-m transmits (provides) the confidential information [GM]ₘ to all the model learning devices 11-1, . . . , 11-N via the control device 13 (step S123-m).

The acquisition unit 112-n of the model learning device 11-n (FIG. 2) to which the confidential information [GM]ₘ (where, m∈{1, . . . , M}) has been sent receives the confidential information [GM]ₘ (confidential information of the information GM for identifying the aggregate model provided from the secure federated learning device 12-m). The acquisition unit 112-n restores the confidential information [GM]ₘ to obtain the information GM for identifying the aggregate model. For example, in a case in which the secure computation method is multiparty computation, the acquisition unit 112-n restores the information GM from a plurality of pieces of different confidential information [GM]ₘ₍₁₎, . . . , [GM]ₘ₍ₘₐₓ₎ (where {m(1), . . . , m(max)}⊆{1, . . . , M}) necessary for restoration. In a case in which the secure computation method is the homomorphic encryption method, the acquisition unit 112-n decrypts the confidential information [GM]ₘ using a decryption key read from the storage unit 111-n to obtain the information GM. The information GM for identifying the aggregate model is stored in the storage unit 111-n (step S112-n).

### [One Example of Asynchronous Control (Step S1331)]

Processing of the federated learning system 1 according to asynchronous control is illustrated. Note that asynchronous control below is an example and does not restrict the present invention.

In asynchronous control, each model learning device 11-n and other model learning devices 11-n′ (where n and n′∈{1, . . . , N}) included in the federated learning system 1 execute local processing asynchronously. That is, the plurality of model learning devices 11-1, . . . , 11-N execute mutually asynchronous local processing. In a case in which asynchronous control is performed, the control unit 133 instructs each model learning device 11-n (FIG. 2) to execute local processing according to asynchronous control. This instruction is acquired by the acquisition unit 112-n and sent to the control unit 116-n. The control unit 116-n executes asynchronous control. In asynchronous control, each model learning device 11-n determines whether or not it is necessary to update an acquired aggregate model to newly obtain a worker model. The model learning device 11-n updates the aggregate model to obtain a new worker model if it is determined that it is necessary to update the aggregate model, and acquires confidential information [GM]ₘ of information GM for identifying a new aggregate model from each secure federated learning device 12-m after the elapse of a standby time without updating the aggregate model to obtain a new worker model if it is determined that it is not necessary to update the aggregate model. Further, in asynchronous control, each secure federated learning device 12-m determines whether or not confidential information [WM-n]ₘ of information WM-n for identifying a worker model is obtained from a predetermined model learning device 11-n. It is not always required to obtain confidential information [WM-n]ₘ of information WM-n for identifying worker models from all the model learning devices 11-n. If it is determined that the confidential information [WM-n]ₘ of the information WM-n for identifying a worker model has been obtained from the predetermined model learning device 11-n, each secure federated learning device 12-m obtains confidential information [GM]ₘ of information GM for identifying an aggregate model obtained by aggregating worker models according to secure computation using the confidential information [WM-n]ₘ of the information WM-n for identifying the worker model. Specific examples will be given hereinafter.

In a case in which asynchronous processing is performed, each model learning device 11-n (FIG. 2) executes processing of steps S113-n, S114-n, and S115-n described above, and the secure federated learning device 12-m (FIG. 3) executes processing of step S121-m. However, in asynchronous processing, the providing unit 115-n of the model learning device 11-n does not transmit synchronization information to the control device 13 in step S115-n.

Further, the determination unit 128-m of each secure federated learning device 12-m determines whether or not registration of a worker model is completed with reference to confidential information [WM-n]ₘ stored in the storage unit 127-m at a predetermined trigger. For example, the determination unit 128-m may periodically perform the determination, or may perform the determination with the storage of each piece of confidential information [WM-n]ₘ in the storage unit 127-m as a trigger. Note that completion of registration of a worker model means that confidential information [WM-n₁]ₘ, . . . , [WM-nₘₐₓ]ₘ of information for identifying a new worker model has been obtained from predetermined model learning devices 11-n₁, . . . , 11-nₘₐₓ (where {n₁, . . . , nₘₐₓ}=[1, . . . , N}). This is not necessarily to obtain all pieces of confidential information [WM-1]ₘ, . . . , [WM-N]ₘ of the information for identifying a new worker model. That is, the determination unit 128-m determines whether or not confidential information [WM-n₁]ₘ, . . . , [WM-nₘₐₓ]ₘ of information for identifying a new worker model has been obtained from at least some model learning devices 11-n₁, . . . , 11-nₘₐₓ. The model learning devices 11-n₁, . . . , 11-nₘₐₓ may be model learning device 11-1, . . . , 11-N (that is, {n₁, . . . , nₘₐₓ}={1, . . . , N}) that have provided confidential information of information for identifying a new worker model at the time of determination, or some model learning devices 11-n₁, . . . , 11-nₘₐₓ (that is, {n₁, . . . , nₘₐₓ}c{1, . . . , N}) set in advance. Further, the confidential information [WM-n₁]ₘ, . . . , [WM-nₘₐₓ]ₘ of the information for identifying a new worker model may be confidential information [WM-n₁]ₘ, . . . , [WM-nₘₐₓ]ₘ that has not yet been used for secure aggregation processing, or confidential information [WM-n₁]ₘ, . . . , [WM-nₘₐₓ]ₘ obtained after the previous secure aggregation processing. However, since the confidential information [WM-n]ₘ is a share in the secure distribution method or ciphertext in the homomorphic encryption method, there is a case in which a model learning device 11-n that has provided the confidential information [WM-n]ₘ cannot be identified from the confidential information [WM-n]ₘ. In such a case, the determination unit 128-m may determine whether or not registration of the worker model has been completed from the total data amount of confidential information [WM-n]ₘ stored in the storage unit 127-m. For example, the determination unit 128-m may determine that registration of the worker model has been completed if the total data amount of confidential information [WM-n]ₘ stored in the storage unit 127-m is equal to the total data amount of confidential information [WM-n₁]ₘ, . . . , [WM-nₘₐₓ]ₘ provided from the predetermined model learning devices 11-n₁, . . . , 11-nₘₐₓ, and determine that registration of the worker model has not been completed if not. Alternatively, the determination unit 128-m may determine that registration of the worker model has been completed if the total number of worker models corresponding to the confidential information [WM-n]ₘ stored in the storage unit 127-m is equal to the total number of worker models of the predetermined model learning devices 11-n₁, . . . , 11-nₘₐₓ, and determine that registration of the worker model has not been completed if not. For example, in a case in which information WM-n for identifying a worker model is a model parameter group, the number of model parameters included in one worker model is N_{MP}, and the total data amount of confidential information [WM-n]ₘ stored in the storage unit 127-m is the number of records N_{R}, the total number of worker models for which the confidential information [WM-n]ₘ has been provided is N_{R}/N_{MP}. In this case, the determination unit 128-m may determine that registration of a worker model has been completed if nₘₐₓ=N_{R}/N_{MP}, and determine that registration of a worker model has not been completed if not. Here, in a case in which it is determined that registration of a worker model has not been completed and it is determined that a predetermined time has not elapsed (time-out has not occurred) from a reference point in time, the determination unit 128-m determines whether or not registration of this worker model has been completed again at a predetermined trigger. For example, the determination unit 128-m may perform the determination again after the elapse of a predetermined standby time, or may perform the determination again with the storage of any confidential information [WM-n]ₘ in the storage unit 127-m as a trigger. On the other hand, in a case in which it is determined that registration of the worker model has been completed or it is determined that a predetermined time has elapsed (time-out has occurred) from the reference point in time, the determination unit 128-m sends an instruction to start secure aggregation processing to the control unit 126-m. Note that an example of the reference point in time of time-out is as described in synchronous control described above (step S128-m).

The control unit 126-m which has received the instruction to start secure aggregation processing instructs the secure aggregation processing unit 122-m to start secure aggregation processing. The secure aggregation processing unit 122-m that has received the instruction reads a plurality of pieces of confidential information [WM-n](where, n∈{1, . . . , N}) (confidential information of information for identifying a plurality of worker models) from the storage unit 127-m, obtains confidential information [GM]ₘ of information GM for identifying an aggregate model obtained by aggregating the plurality of worker models, and output the aggregate model through secure computation using the confidential information [WM-n]without obtaining the plurality of worker models. That is, in a case in which it is determined that the confidential information [WM-n₁]ₘ, . . . , [WM-nₘₐₓ]ₘ of the information for identifying worker models has been obtained from the predetermined model learning devices 11-n₁, . . . , 11-nₘₐₓ, the secure aggregation processing unit 122-m obtains and outputs confidential information [GM]ₘ of information GM for identifying an aggregate model obtained by aggregating the plurality of worker models through secure computation using the confidential information [WM-n₁]ₘ, . . . , [WM-nₘₐₓ]ₘ of the information for identifying the worker models. The confidential information [GM]ₘ of the information GM for identifying the aggregate model is sent to the providing unit 123-m (step S122′-m).

The acquisition unit 112-n of the model learning device 11-n (FIG. 2) accesses the providing unit 123-m of the secure federated learning device 12-m (where me{1, . . . , M}) (FIG. 3) and acquires the confidential information [GM]ₘ of the information GM for identifying the aggregate model from the providing unit 123-m at a predetermined trigger. The acquisition unit 112-n restores the acquired confidential information [GM]ₘ to obtain the information GM for identifying the aggregate model. The information GM for identifying the aggregate model is stored in the storage unit 111-n (step S112′-n).

The determination unit 117-n updates the aggregate model corresponding to the information GM stored in the storage unit 111-n and determines whether or not it is necessary to newly obtain a worker model. In other words, the determination unit 117-n determines whether or not it is necessary to obtain a worker model by updating the latest aggregate model identified by the information GM through machine learning using the local learning data D-n. For example, if the aggregate model is the same as or approximate to the “latest aggregate model” already used for generation of the worker model (step S113-n), the determination unit 117-n determines that it is not necessary to update the aggregate model to obtain a new worker model, and if not, determines that it is necessary to update the aggregate model to obtain a new worker model. Note that approximation of two aggregate models may be, for example, that the distance between model parameters thereof is equal to or less than a predetermined value, or that the difference between output distributions of the two aggregated models for a predetermined input group is equal to or less than a predetermined value (step S117a-n).

Here, in a case in which it is determined that it is not necessary to update the aggregate model to obtain a new worker model, the learning unit 113-n does not update the aggregate model to obtain a new worker model, and the acquisition unit 112-n acquires confidential information [GM]ₘ of information for identifying a new aggregate model from the secure federated learning device 12-m (where me{1, . . . , M}) (FIG. 3) after the elapse of a standby time. That is, the learning unit 113-n does not obtain a new worker model, and the acquisition unit 112-n accesses the providing unit 123-m after the elapse of the standby time and acquires the confidential information [GM]ₘ of the information GM for identifying the aggregate model from the providing unit 123-m. The acquisition unit 112-n restores the acquired confidential information [GM]ₘ to obtain the information GM for identifying the aggregate model, stores the information GM in the storage unit 111-n, and returns to steps S117a-n (steps S117b-n).

On the other hand, in a case in which it is determined that it is necessary to update the aggregate model to newly obtain a worker model, the learning unit 113-n reads the local learning data D-n and the latest information GM stored in the storage unit 111-n, updates the latest aggregate model identified by the information GM to obtain a worker model through machine learning using the local learning data D-n, and outputs information WM-n for identifying the worker model (step S113-n). Thereafter, processing of step S114-n and subsequent processing which have been described so far in the present embodiment are executed again.

### Features of Present Embodiment

In the present embodiment, the model learning device executes local processing for updating an aggregate model through machine learning using local learning data to obtain information for identifying a worker model and providing confidential information of the information for identifying the worker model to the secure federated learning device. Further, the secure federated learning device executes secure aggregation processing for obtaining confidential information of information for identifying a new aggregate model obtained by aggregating the plurality of worker models through secure computation using the obtained confidential information of the information for identifying the worker models without obtaining the worker models, and providing the information for identifying the new aggregate model or confidential information of the information for identifying the new aggregate model to the plurality of model learning devices. The control device compares a local processing time corresponding to local processing with an aggregation processing time corresponding to secure aggregation processing, performs asynchronous control for causing local processing of the plurality of model learning devices to be executed asynchronously in a case in which the local processing time is longer than the aggregation processing time or the local processing time is equal to or longer than the aggregation processing time, and performs synchronous control for synchronizing local processing of the plurality of model learning devices in a case in which asynchronous control is not performed. In this case, since the secure federated learning device cannot obtain the worker model itself, the tendency of learning data held by each model learning device cannot be ascertained on the basis of differences between the worker model and the aggregate model. Accordingly, the safety of federated learning can be improved. Furthermore, since synchronous control and asynchronous control are switched according to the relation between the local processing time and the aggregation processing time, processing of the entire federated learning system can be made efficient according to the processing speed of each model learning device.

### Second Embodiment

A second embodiment is a modified example of the first embodiment. In synchronous control of the present embodiment, the secure federated learning device is caused to execute secure aggregation processing using confidential information of information for identifying a worker model whose contribution to a new aggregate model is equal to or greater than a reference value or exceeding the reference value without using confidential information of information for identifying a worker model whose contribution is less than the reference value or equal to or less than the reference value. Accordingly, even in synchronous processing, the secure federated learning device can execute secure aggregation processing without waiting for confidential information of information for identifying a worker model having a low contribution. The merit of starting secure aggregation processing at an early stage is larger than the merit of waiting for confidential information of information for identifying a worker model having a low contribution, and the processing can be made efficient as a whole. In the following, descriptions will be simplified by using the same reference signs for items which have already been described.

### <Configuration>

As illustrated in FIG. 1, a federated learning system 2 of the present embodiment includes N model learning devices 11-1, . . . , 11-N for performing model learning, M secure federated learning devices 22-1, . . . , 22-M for performing federated learning through secure computation, and a control device 23 for controlling the federated learning system 2.

As illustrated in FIG. 3, the secure federated learning device 22-m of the present embodiment includes an acquisition unit 121-m, a secure aggregation processing unit 222-m, a providing unit 123-m, a control unit 126-m, a storage unit 127-m, and a determination unit 128-m. The secure federated learning device 22-m executes each kind of processing on the basis of control of the control unit 126-m, and input information and information obtained through each kind of processing are stored in the storage unit 127-m and read and used as necessary.

As illustrated in FIG. 4, the control device 23 of the present embodiment includes a measurement unit 131, a comparison unit 132, and a control unit 233.

### <Preprocessing>

The same as the first embodiment applies.

### <Learning Processing>

Learning processing of the present embodiment will be described using FIG. 5.

In the present embodiment, local processing and secure aggregation processing are also alternately repeated until end conditions are satisfied. In this case, a new aggregate model corresponding to the confidential information [GM]ₘ obtained through secure aggregation processing is used as an aggregate model in the next local processing.

The measurement unit 231 (FIG. 4) of the control device 23 measures a local processing time T₁ corresponding to local processing and an aggregation processing time T₂ corresponding to secure aggregation processing in the federated learning system 2. The measured local processing time T₁ and aggregation processing time T₂ are sent to the comparison unit 132 (step S131).

The comparison unit 132 of the control device 23 compares the sent local processing time T₁ with the aggregation processing time T₂ (step S132). Here, in a case in which the local processing time T₁ is longer than the aggregation processing time T₂ (T₁>T₂) or the local processing time T₁ is equal to or longer than the aggregation processing time T₂ (T₁≥T₂), the control unit 233 performs asynchronous control for causing the plurality of model learning devices 11-1, . . . , 11-N to execute local processing asynchronously (step S1331). Thereafter, processing returns to step S131. On the other hand, in a case in which asynchronous control is not performed, the control unit 233 performs synchronous control for synchronizing local processing of the plurality of model learning devices 11-1, . . . , 11-N (step S1332). Further, in the present embodiment, in a case in which synchronous control is performed, the control unit 233 causes the secure federated learning devices 22-1, . . . , 22-M to execute secure aggregation processing using confidential information of information for identifying a worker model whose contribution to a new aggregate model is equal to or greater than a reference value or exceeds the reference value (hereinafter referred to as “selective synchronous aggregation processing) without using confidential information of information for identifying a worker model whose contribution is less than the reference value or equal to or less than the reference value. A contribution of a worker model to a new aggregate model may be any index. For example, a Shapley value (for example, an index used in FedCoine) may be used as a contribution (step S233).

Asynchronous control (step S1331) of the present embodiment is the same as asynchronous control of the first embodiment.

Hereinafter, an example of synchronous control (steps S1332 and S233) accompanied by selective synchronous aggregation processing of the present embodiment will be described.

### [One Example of Synchronous Control (Steps S1332 and S233) Accompanied by Selective Synchronous Aggregation Processing]

The control unit 233 instructs each model learning device 11-n (FIG. 2) to execute local processing through synchronous control. Each model learning device 11-n instructed to execute local processing through synchronous control executes steps S113-n and S114-n described in the first embodiment.

The confidential information [WM-n]={[WM-n]₁, . . . , [WM-n]_{M}} of the information WM-n for identifying worker models is input to the providing unit 115-n. The providing unit 115-n transmits (provides) confidential information [WM-n]ₘ of the information WM-n for identifying the corresponding worker model to the secure federated learning device 22-m (FIG. 3) (where m=1, . . . , M). Further, the providing unit 115-n sends synchronization information indicating that the model learning device 11-n has transmitted the confidential information [WM-n]ₘ to the secure federated learning device 12-m to the control device 23 (step S115-n).

The acquisition unit 121-m of the secure federated learning device 22-m (FIG. 3) receives confidential information [WM-n]ₘ of information WM-n for identifying a worker model sent from the model learning device 11-n and stores the confidential information [WM-n]ₘ in the storage unit 127-m (step S121-m).

The control unit 233 of the control device 23 for executing selective synchronous aggregation processing obtains a contribution of a worker model acquired by each model learning device 11-n (n=1, . . . , N) to an aggregate model. For example, the control unit 233 receives information WM-n for identifying worker models and information GM for identifying an aggregate model obtained by aggregating the worker models from the respective model learning devices 11-n one by one or periodically and calculates contributions. Alternatively, each secure federated learning device 22-m may use confidential information [WM-n]ₘ of information WM-n for identifying a worker model and confidential information [GM]ₘ of information GM for identifying an aggregate model obtained using the confidential information [WM-n]ₘ, calculate confidential information of the corresponding contribution through secure computation, and transmit the confidential information to the control device 23. In this case, the control unit 233 restores the contribution from the confidential information of the contribution sent from each secure federated learning device 22-m. The control unit 233 determines whether confidential information [WM-n]₁, . . . , [WM-n]_{M} corresponding to worker models having contributions that are equal to or greater than a reference value or exceed the reference value has been transmitted to all secure federated learning devices 22-1, . . . , 22-M on the basis of the obtained contributions and synchronization information (step S2332a). Here, in a case in which it is determined that the confidential information [WM-n]₁, . . . , [WM-n]_{M} corresponding to worker models having contributions that are equal to or greater than the reference value or exceed the reference value has not been transmitted to all secure federated learning devices 22-1, . . . , 22-M, and it is determined that a predetermined time has not elapsed from a reference point in time (time-out has not occurred), the control unit 233 performs determination of step S2332a at every certain interval. On the other hand, in a case in which it is determined that the confidential information [WM-n]₁, . . . , [WM-n]_{M} corresponding to worker models having contributions that are equal to or greater than the reference value or exceed the reference value has been transmitted to all secure federated learning devices 22-1, . . . , 22-M or it is determined that the predetermined time has elapsed from the reference point in time (time-out has occurred), the control unit 233 sends an instruction to start secure aggregation processing to the secure federated learning devices 22-1, . . . , 22-M (S2332b).

The instruction to start secure aggregation processing is received by the acquisition unit 121-m of the secure federated learning device 22-m (where m=1, . . . , M) (FIG. 3), and input to the control unit 126-m. The control unit 126-m that has received the instruction to start secure aggregation processing instructs the secure aggregation processing unit 222-m to start secure aggregation processing. The secure aggregation processing unit 222-m that has received the instruction reads a plurality of pieces of confidential information [WM-n](where, n∈{1, . . . , N}) (confidential information of information for identifying a plurality of worker models) from the storage unit 127-m, obtains confidential information [GM]ₘ of information GM for identifying an aggregate model obtained by aggregating the plurality of worker models, and output the aggregate model through secure computation using the confidential information [WM-n]without obtaining the plurality of worker models. The confidential information [GM]ₘ of the information GM for identifying the aggregate model is sent to the providing unit 123-m (step S222-m).

The confidential information [GM]ₘ is input to the providing unit 123-m. The providing unit 123-m transmits (provides) the confidential information [GM]ₘ to the plurality of model learning devices 11-n (where n∈{1, . . . , N}) via the control device 13 (step S123-m).

The acquisition unit 112-n of the model learning device 11-n (FIG. 2) to which the confidential information [GM]ₘ (where, m∈{1, . . . , M}) has been sent receives the confidential information [GM]ₘ (confidential information of the information GM for identifying the aggregate model provided from the secure federated learning device 22-m)). The acquisition unit 112-n restores the confidential information [GM]ₘ to obtain the information GM for identifying the aggregate model. The Information GM for identifying the aggregate model is stored in the storage unit 111-n (step S112-n).

### Features of Present Embodiment

The present embodiment can obtain the same effects as those described in the first embodiment. Further, in synchronous control of the present embodiment, the secure federated learning device is caused to execute secure aggregation processing using confidential information of information for identifying a worker model whose contribution to a new aggregate model is equal to or greater than a reference value or exceeds the reference value without using confidential information of information for identifying a worker model whose contribution is less than the reference value or equal to or less than the reference value. Accordingly, the efficiency can be further improved.

### Third Embodiment

A third embodiment is a modified example of the first embodiment. In the present embodiment, in a case in which asynchronous control is performed and a local processing time is not longer than an aggregation processing time by a predetermined time or more, the secure federated learning device is caused to execute secure aggregation processing which does not consider a contribution. In such a case, although the secure federated learning device side has a time margin more than the model learning device side, the difference therebetween is not significant. In such a case, it is more efficient as a whole to execute secure aggregation processing without considering a contribution of confidential information of information for identifying a worker model. On the other hand, in a case in which asynchronous control is performed and the local processing time is longer than the aggregation processing time by a predetermined time or more, the secure federated learning device is caused to execute secure aggregation processing using confidential information of information for identifying a worker model having a contribution equal to or greater than a reference value or exceeding the reference value without using confidential information of information for identifying a worker model having a contribution less than the reference value or equal to or less than the reference value. In such a case, the secure federated learning device side has a much time margin compared with the model learning device side. In such a case, the merit of starting secure aggregation processing at an early stage is larger than the merit of waiting for confidential information of information for identifying a worker model having a low contribution, and the processing can be made efficient as a whole.

### <Configuration>

As illustrated in FIG. 1, a federated learning system 3 of the present embodiment includes N model learning devices 11-1, . . . , 11-N for performing model learning, M secure federated learning devices 32-1, . . . , 32-M for performing federated learning through secure computation, and a control device 33 for controlling the federated learning system 3.

As illustrated in FIG. 3, the secure federated learning device 32-m of the present embodiment includes an acquisition unit 121-m, a secure aggregation processing unit 322-m, a providing unit 123-m, a control unit 126-m, a storage unit 127-m, and a determination unit 128-m. The secure federated learning device 32-m executes each kind of processing on the basis of control of the control unit 126-m, and input information and information obtained through each kind of processing are stored in the storage unit 127-m and read and used as necessary.

As illustrated in FIG. 4, the control device 33 of the present embodiment includes a measurement unit 131, a comparison unit 332, and a control unit 333.

### <Preprocessing>

The same as the first embodiment applies.

### <Learning Processing>

Learning processing of the present embodiment will be described using FIG. 5.

In the present embodiment, local processing and secure aggregation processing are also alternately repeated until end conditions are satisfied. In this case, a new aggregate model corresponding to the confidential information [GM]ₘ obtained through secure aggregation processing is used as an aggregate model in the next local processing.

The comparison unit 332 of the control device 33 compares the sent local processing time T₁ with the aggregation processing time T₂ (step S132). Here, in a case in which the local processing time T₁ is longer than the aggregation processing time T₂ (T₁>T₂) or the local processing time T₁ is equal to or longer than the aggregation processing time T₂ (T₁≥T₂), the control unit 333 performs asynchronous control for causing the plurality of model learning devices 11-1, . . . , 11-N to execute local processing asynchronously (step S1331). In the present embodiment, in a case in which asynchronous control is performed, the comparison unit 332 further determines whether or not the local processing time T₁ is longer than the aggregation processing time T₂ by a predetermined time A or more (that is, determines whether or not T₁≥T₂+A). Here, A is a positive real number representing time. The comparison unit 332 may compare T₁ with T₂+A to determine whether or not T₁≥T₂+A is satisfied or may compare T₁ with a value α smaller than T₂+A to determine whether or not T₁>α is satisfied (step S332).

Here, in a case in which it is determined that the local processing time T₁ is not longer than the aggregation processing time T₂ by the predetermined time A or more (T₂<T₁<T₂+A or T₂≤T₁<T₂+A), the control unit 333 causes secure federated learning devices 32-1, . . . , 32-M to execute secure aggregation processing which does not consider a contribution. In such a case, although the side of the secure federated learning devices 32-1, . . . , 32-M has time margins more than the side of the model learning devices 11-1, . . . , 11-N, the difference therebetween is not significant. In such a case, it is more efficient as a whole to execute secure aggregation processing without considering a contribution of confidential information of information for identifying a worker model. Thereafter, processing returns to step S131 (step S3331). On the other hand, in a case in which it is determined that the local processing time T₁ is longer than the aggregation processing time T₂ by the predetermined time A or more (T₁≥T₂+A), the control unit 333 causes the secure federated learning devices 32-1, . . . , 32-M to execute secure aggregation processing using confidential information of information for identifying a worker model whose contribution to a new aggregate model is equal to or greater than a reference value or exceeds the reference value (hereinafter referred to as “selective asynchronous aggregation processing) without using confidential information of information for identifying a worker model having a contribution less than the reference value or equal to or less than the reference value. In such a case, the side of the secure federated learning devices 32-1, . . . , 32-M has much time margin compared with the side of the model learning devices 11-1, . . . , 11-N. In such a case, the merit of starting secure aggregation processing at an early stage is larger than the merit of waiting for confidential information of information for identifying a worker model having a low contribution, and the processing can be made efficient as a whole. Thereafter, processing returns to step S131. (Step S3332).

On the other hand, in a case in which asynchronous control is not performed, the control unit 233 performs synchronous control for synchronizing local processing of the plurality of model learning devices 11-1, . . . , 11-N (step S1332). After that, the process returns to step S131.

Synchronous control (step S1332) of the present embodiment is the same as the synchronous control of the first embodiment. In addition, secure aggregation processing (step S3331) which does not consider a contribution in asynchronous control is the same as secure aggregation processing in asynchronous control described in the first embodiment. An example of selective asynchronous aggregation processing (step S3332) of the present embodiment will be described below.

### [One Example of Selective Asynchronous Aggregation Processing (Step S3332)]

The control unit 333 instructs each model learning device 11-n (FIG. 2) to execute local processing according to asynchronous control. Each model learning device 11-n instructed to execute local processing according to synchronous control executes processing of steps S113-n, S114-n, and S115-n described in the first embodiment, and the secure federated learning device 32-m (FIG. 3) executes processing of step S121-m. However, in asynchronous processing, the providing unit 115-n of the model learning device 11-n does not transmit synchronization information to the control device 33 in step S115-n.

The control unit 333 of the control device 33 for executing selective asynchronous aggregation processing obtains a contribution of a worker model obtained by each model learning device 11-n (n=1, . . . , N) to an aggregate model. For example, the control unit 333 obtains a contribution through the method illustrated in the second embodiment. The obtained contribution corresponding to each piece of confidential information [WM-n]ₘ is sent to each secure federated learning device 32-m. The contribution corresponding to each piece of confidential information [WM-n]ₘ is received by the acquisition unit 121-m of each secure federated learning device 32-m and sent to the determination unit 128-m. The determination unit 128-m of each secure federated learning device 32-m determines whether or not registration of the worker model has been completed with reference to confidential information [WM-n]ₘ stored in the storage unit 127-m at a prescribed trigger. Completion of registration of a worker model in selective asynchronous aggregation processing means that all pieces of confidential information [WM-n]₁, . . . , [WM-n]_{M} corresponding to worker models having contributions equal to or greater than a reference value or exceeding the reference value have been obtained. Here, in a case in which it is determined that registration of a worker model has not been completed and it is determined that a predetermined time has not elapsed (time-out has not occurred) from a reference point in time, the determination unit 128-m determines whether or not registration of this worker model has been completed again at a predetermined trigger. On the other hand, in a case in which it is determined that registration of the worker model has been completed or it is determined that a predetermined time has elapsed (time-out has occurred) from a reference point in time, the determination unit 128-m transmits an instruction to start secure aggregation processing to the control unit 126-m (step S328-m).

The control unit 126-m which has received the instruction to start secure aggregation processing instructs the secure aggregation processing unit 122-m to start secure aggregation processing. The secure aggregation processing unit 122-m that has received the instruction reads a plurality of pieces of confidential information [WM-n](where, n∈{1, . . . , N}) (confidential information of information for identifying a plurality of worker models) from the storage unit 127-m, obtains confidential information [GM]ₘ of information GM for identifying an aggregate model obtained by aggregating the plurality of worker models, and output the aggregate model through secure computation using the confidential information [WM-n]without obtaining the plurality of worker models. The confidential information [GM]ₘ of the information GM for identifying the aggregate model is sent to the providing unit 123-m (step S322-m). Thereafter, processing of step S112′-n and subsequent processing of asynchronous control of the first embodiment are executed.

### Features of Present Embodiment

The present embodiment can obtain the same effects as those described in the first embodiment. Further, in asynchronous control of the present embodiment, in a case in which the local processing time is not longer than the aggregation processing time by a predetermined time or more, the secure federated learning device is caused to execute secure aggregation processing which does not consider a contribution. On the other hand, in asynchronous control, in a case in which the local processing time is longer than the aggregation processing time by a predetermined time or more, the secure federated learning device is caused to execute secure aggregation processing using confidential information of information for identifying a worker model having a contribution equal to or greater than the reference value or exceeding the reference value without using confidential information of information for identifying a worker model having a contribution less than the reference value or equal to or less than the reference value. Accordingly, the efficiency can be further improved.

### Modified Example 1 of Third Embodiment

The second embodiment and the third embodiment may be combined. That is, the following processing may be performed. In synchronous control, as described in the second embodiment, the secure federated learning device is caused to execute secure aggregation processing using confidential information of information for identifying a worker model whose contribution to a new aggregate model is equal to or greater than a reference value or exceeds the reference value without using confidential information of information for identifying a worker model whose contribution is less than the reference value or equal to or less than the reference value. In asynchronous control, in a case in which a local processing time is not longer than an aggregation processing time by a predetermined time or more, the secure federated learning device is caused to execute secure aggregation processing which does not consider a contribution. On the other hand, in asynchronous control, in a case in which the local processing time is longer than the aggregation processing time by a predetermined time or more, the secure federated learning device is caused to execute secure aggregation processing using confidential information of information for identifying a worker model having a contribution equal to or greater than the reference value or exceeding the reference value without using confidential information of information for identifying a worker model having a contribution less than the reference value or equal to or less than the reference value. Accordingly, the efficiency can be further improved.

### Fourth Embodiment

Secure aggregation processing in the first, second, and third embodiments and modified example 1 of the third embodiment described above is processing in which the secure federated learning devices 12-m, 22-m, and 32-m obtain confidential information [GM]ₘ of information GM for identifying a new aggregate model obtained by aggregating a plurality of worker models through secure computation using acquired confidential information [Wm-n]without obtaining the worker models, and provides the confidential information [GM]ₘ of the information GM for identifying the new aggregate model to the plurality of model learning devices 11-n. However, in this secure aggregation processing, any secure federated learning device may provide the information GM for identifying the new aggregate model instead of the confidential information [GM]ₘ of the information GM for identifying the new aggregate model to the model learning devices 11-1, . . . , 11-N. In this case, the secure federated learning device restores the information GM for identifying the new aggregate model from confidential information of information GM for identifying a plurality of new aggregate models and provides the information GM to the model learning devices 11-1, . . . , 11-N.

### [Hardware Configuration]

The model learning devices 11-m and 14-m, the federated learning devices 12-m, 22-m, and 32-m, and the control devices 13, 23, and 33 in the respective embodiments are devices configured by causing a general-purpose or dedicated computer including a processor (hardware processor) such as a central processing unit (CPU) and a memory such as a random-access memory (RAM) and a read-only memory (ROM) to execute a predetermined program, for example. That is, the model learning devices 11-m and 14-m, the federated learning devices 12-m, 22-m, and 32-m, and the control devices 13, 23, and 33 in the respective embodiments include, for example, processing circuitry configured to implement each unit of the devices. This computer may have one processor and one memory or may have a plurality of processors and a plurality of memories. This program may be installed in a computer or may be recorded in a ROM or the like in advance. Furthermore, some or all of the processing units may be configured by using an electronic circuit which realizes a processing function independently, instead of an electronic circuit (circuitry) such as a CPU which realizes a function configuration by reading a program. Further, an electronic circuit constituting one device may include a plurality of CPUs.

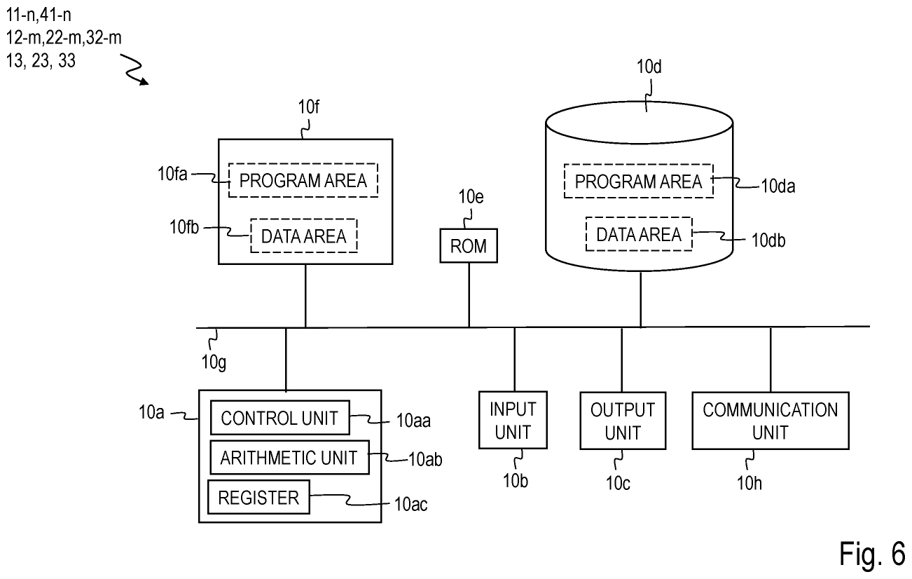

FIG. 6 is a block diagram illustrating a hardware configuration of the model learning devices 11-m and 14-m, the federated learning devices 12-m, 22-m, and 32-m, and the control devices 13, 23, and 33 in the respective embodiments. As illustrated in FIG. 6, each of the model learning devices 11-m and 14-m, the federated learning devices 12-m, 22-m, and 32-m, and the control devices 13, 23, and 33 in this example includes a central processing unit (CPU) 10a, an input unit 10b, an output unit 10c, a random access memory (RAM) 10d, a read-only memory (ROM) 10e, an auxiliary storage device 10f, a communication unit 10h, and a bus 10g. The CPU 10a in this example has a control unit 10aa, an arithmetic unit 10ab, and a register 10ac and executes various arithmetic processes in accordance with various programs read into the register 10ac. In addition, the input unit 10b is an input terminal, a keyboard, a mouse, a touch panel, or the like to which data is input. Further, the output unit 10c is an output terminal, a display, or the like from which data is output. The communication unit 10h is a LAN card or the like controlled by the CPU 10a which has read a predetermined program. In addition, the RAM 10d is a static random access memory (SRAM), a dynamic random access memory (DRAM), or the like and has a program region 10da in which a predetermined program is stored and a data region 10db in which various data are stored. Moreover, the auxiliary storage device 10f is, for example, a hard disk, a magneto-optical (MO) disc, a semiconductor memory, or the like and has a program area 10fa in which a predetermined program is stored and a data area 10fb in which various data are stored. Further, the bus 10g connects the CPU 10a, the input unit 10b, the output unit 10c, the RAM 10d, the ROM 10e, the communication unit 10h, and the auxiliary storage device 10f such that information can be exchanged therebetween. The CPU 10a writes the program stored in the program area 10fa of the auxiliary storage device 10f to the program region 10da of the RAM 10d in accordance with the read operating system (OS) program. Likewise, the CPU 10a writes various types of data stored in the data area 10fb of the auxiliary storage device 10f into the data region 10db of the RAM 10d. In addition, the address on the RAM 10d in which this program or data is written is stored in the register 10ac of the CPU 10a. The control unit 10aa of the CPU 10a sequentially reads these addresses stored in the register 10ac, reads the program or data from the region on the RAM 10d indicated by the read address, causes the arithmetic unit 10ab to sequentially execute the operations indicated by the program, and stores the arithmetic result in the register 10ac. With such a configuration, the functional configurations of the model learning devices 11-m and 14-m, the federated learning devices 12-m, 22-m, and 32-m, and the control devices 13, 23, and 33 are realized.

The above program can be recorded on a computer-readable recording medium. An example of a computer-readable recording medium is a non-transitory recording medium. Examples of such recording media include a magnetic recording device, an optical disk, a magneto-optical recording medium, a semiconductor memory, and the like.

Further, distribution of this program is performed, for example, by selling, transferring, or renting a portable recording medium such as a DVD or CD-ROM on which the program has been recorded. Further, the program may be distributed by being stored in a storage device of a server computer and transferred from the server computer to another computer via a network. As described above, the computer which executes such a program first temporarily stores, for example, the program recorded on the portable recording medium or the program transferred from the server computer in its own storage device. Furthermore, when processing is performed, the computer reads the program stored in its own storage device and performs the process according to the read program. Furthermore, as another execution form of this program, a computer may read the program directly from a portable recording medium and execute processing according to the program and the processing according to the received program may be executed sequentially every time the program is transferred from the server computer to this computer. Furthermore, instead of transferring the program from the server computer to the computer, the processing described above may be executed by a so-called ASP (Application Service Provider) type service, in which a processing function is realized by execution instructions and result acquisition alone. Note that the program according to the present embodiment includes information to be used for processing by an electronic computer and equivalent to the program (data which is not a direct command to the computer but has a property that regulates the processing of the computer and the like).

Although the device is configured by executing a predetermined program on a computer in each embodiment, at least a part of these processing contents may be implemented by hardware.

Note that the present invention is not limited to the above-described embodiment. For example, the various processing described above may not only be executed in chronological order in accordance with the description, but may also be executed in parallel or individually according to the processing capacity of the device that executes the processing or as required. In addition, it goes without saying that changes can be made as appropriate without departing from the spirit of the present invention.

### REFERENCE SIGNS LIST

1, 2, 3 Federated learning system
11-m, 14-m Model learning device
111-n Storage unit
112-n Acquisition unit
113-n Learning unit
114-n Concealment unit
115-n Provision unit
117-n Determination unit
12-m, 22-m, 32-m
121-m Acquisition unit
122-m, 222-m, 322-m Secure aggregation processing unit
123-m Provision unit
127-m Storage unit
128-m Determination unit
13, 23, 33 Control device
131 Measurement unit
132, 332 Comparison unit
133, 233, 333 Control unit

1. A control device for controlling a federated learning system including a plurality of model learning devices and a single or a plurality of secure federated learning devices,
wherein the model learning devices execute local processing for updating an aggregate model through machine learning using local learning data to obtain information for identifying worker models and providing confidential information of information for identifying the worker models to the secure federated learning device, and
the secure federated learning device executes secure aggregation processing for obtaining confidential information of information for identifying a new aggregate model obtained by aggregating the plurality of worker models through secure computation using the obtained confidential information of the information for identifying the worker models without obtaining the worker models, and providing the information for identifying the new aggregate model or confidential information of the information for identifying the new aggregate model to the plurality of model learning devices,
the control device comprising processing circuitry configured to:
compare a local processing time corresponding to the local processing with an aggregation processing time corresponding to the secure aggregation processing; and
perform asynchronous control for causing the local processing of the plurality of model learning devices to be executed asynchronously in a case in which the local processing time is longer than the aggregation processing time or the local processing time is equal to or longer than the aggregation processing time and to perform synchronous control for synchronizing the local processing of the plurality of model learning devices in a case in which the asynchronous control is not performed.

2. The control device according to claim 1, wherein in a case in which the synchronous control is performed,
the processing circuitry causes the secure federated learning device to execute the secure aggregation processing using confidential information of information for identifying a worker model whose contribution to the new aggregate model is equal to or greater than a reference value or exceeds the reference value without using confidential information of information for identifying a worker model whose contribution is less than the reference value or equal to or less than the reference value.

3. The control device according to claim 2, wherein
the processing circuitry causes the secure federated learning device to execute the secure aggregation processing that does not consider a contribution in a case in which the asynchronous control is performed, and the local processing time is not longer than the aggregation processing time by a predetermined time or more, and
causes the secure federated learning device to execute the secure aggregation processing using confidential information of information for identifying a worker model having a contribution equal to or greater than the reference value or exceeding the reference value without using confidential information of information for identifying a worker model having a contribution less than the reference value or equal to or less than the reference value in a case in which the asynchronous control is performed, and the local processing time is longer than the aggregation processing time by the predetermined time or more.

4. A model learning device of a federated learning system including a plurality of model learning devices and a single or a plurality of secure federated learning devices, the model learning device comprising:
a storage configured to store local learning data; and
processing circuitry configured to:
acquire information for identifying an aggregate model or confidential information of the information for identifying the aggregate model from the secure federated learning device;
update the aggregate model by machine learning using the local learning data to obtain a worker model;
obtain confidential information of information for identifying the worker model; and
provide the confidential information of the information for identifying the worker model to the secure federated learning device,
wherein local processing is processing in which the model learning device updates the aggregate model by machine learning using the local learning data to obtain information for identifying the worker model and provides confidential information of the information for identifying the worker model to the secure federated learning device,
a local processing time is a time corresponding to the local processing,
secure aggregation processing is processing in which the secure federated learning device obtains confidential information of information for identifying a new aggregate model obtained by aggregating a plurality of worker models through secure computation using the acquired confidential information of the information for identifying the worker model without obtaining the worker models, and provides the information for identifying the new aggregate model or the confidential information of the information for identifying the new aggregate model to the plurality of model learning devices,
an aggregation processing time is a time corresponding to the secure aggregation processing, and
the model learning device is configured to:
execute the local processing asynchronously with other model learning devices included in the federated learning system in a case in which the local processing time is longer than the aggregation processing time or the local processing time is equal to or longer than the aggregation processing time; and
execute the local processing in synchronization with other model learning devices included in the federated learning system in a case in which the local processing is not executed asynchronously.

5. A secure federated learning device of a federated learning system including a plurality of model learning devices and a single or a plurality of secure federated learning devices, the secure federated learning device comprising processing circuitry configured to:
acquire confidential information of information for identifying a plurality of worker models from the plurality of model learning devices;
obtain confidential information of information for identifying a new aggregate model obtained by aggregating the plurality of worker models through secure computation using the confidential information of the information for identifying the plurality of worker models without obtaining the worker models; and
provide the information for identifying the new aggregate model or the confidential information of the information for identifying the new aggregate model to the plurality of model learning devices,
wherein local processing is processing in which the model learning devices update an aggregate model by machine learning using local learning data to obtain the information for identifying the worker models and provide confidential information of the information for identifying the worker models to the secure federated learning device,
a local processing time is a time corresponding to the local processing,
secure aggregation processing is processing in which the secure federated learning device obtains the confidential information of the information for identifying the new aggregate model obtained by aggregating the plurality of worker models through secure computation using the acquired confidential information of the information for identifying the worker models without obtaining the worker models, and provides the information for identifying the new aggregate model or the confidential information of the information for identifying the new aggregate model to the plurality of model learning devices,
an aggregation processing time is a time corresponding to the secure aggregation processing, and
the processing circuitry is configured to:
perform asynchronous acquisition processing for obtaining the confidential information of the information for identifying the worker models obtained through asynchronous local processing of the plurality of model learning devices in a case in which the local processing time is longer than the aggregation processing time or the local processing time is equal to or longer than the aggregation processing time; and
perform synchronous acquisition processing for obtaining the confidential information of the information for identifying the worker models obtained through synchronized local processing of the plurality of model learning devices in a case in which the asynchronous acquisition processing is not performed.

6. A control method performed by a control device for controlling a federated learning system including a plurality of model learning devices and a single or a plurality of secure federated learning devices,
wherein the model learning devices execute local processing for updating an aggregate model through machine learning using local learning data to obtain information for identifying worker models and providing confidential information of information for identifying the worker models to the secure federated learning device, and
the secure federated learning device executes secure aggregation processing for obtaining confidential information of information for identifying a new aggregate model obtained by aggregating the plurality of worker models through secure computation using the obtained confidential information of the information for identifying the worker models without obtaining the worker models, and providing the information for identifying the new aggregate model or confidential information of the information for identifying the new aggregate model to the plurality of model learning devices,
the control method comprising:
comparing a local processing time corresponding to the local processing with an aggregation processing time corresponding to the secure aggregation processing; and
performing asynchronous control for causing the local processing of the plurality of model learning devices to be executed asynchronously in a case in which the local processing time is longer than the aggregation processing time or the local processing time is equal to or longer than the aggregation processing time and performs synchronous control for synchronizing the local processing of the plurality of model learning devices in a case in which the asynchronous control is not performed.

7. A model learning method performed by a model learning device of a federated learning system including a plurality of model learning devices and a single or a plurality of secure federated learning devices, the model learning method comprising:
acquiring information for identifying an aggregate model or confidential information of the information for identifying the aggregate model from the secure federated learning device;
updating the aggregate model by machine learning using local learning data stored in a storage of the model learning device to obtain a worker model;
obtaining confidential information of information for identifying the worker model; and
providing the confidential information of the information for identifying the worker model to the secure federated learning device,
wherein local processing is processing in which the model learning device updates the aggregate model by machine learning using the local learning data to obtain information for identifying the worker model and provides confidential information of the information for identifying the worker model to the secure federated learning device,
a local processing time is a time corresponding to the local processing,
secure aggregation processing is processing in which the secure federated learning device obtains confidential information of information for identifying a new aggregate model obtained by aggregating a plurality of worker models through secure computation using the acquired confidential information of the information for identifying the worker model without obtaining the worker models, and provides the information for identifying the new aggregate model or the confidential information of the information for identifying the new aggregate model to the plurality of model learning devices,
an aggregation processing time is a time corresponding to the secure aggregation processing, and
the model learning device is configured to:
execute the local processing asynchronously with other model learning devices included in the federated learning system in a case in which the local processing time is longer than the aggregation processing time or the local processing time is equal to or longer than the aggregation processing time, and
execute the local processing in synchronization with other model learning devices included in the federated learning system in a case in which the local processing is not executed asynchronously.

8. A secure federated learning method performed by a secure federated learning device of a federated learning system including a plurality of model learning devices and a single or a plurality of secure federated learning devices, the secure federated learning method comprising:
obtaining confidential information of information for identifying a plurality of worker models from the plurality of model learning devices;
obtaining confidential information of information for identifying a new aggregate model obtained by aggregating the plurality of worker models through secure computation using the confidential information of the information for identifying the plurality of worker models without obtaining the worker models; and
providing the information for identifying the new aggregate model or the confidential information of the information for identifying the new aggregate model to the plurality of model learning devices,
wherein local processing is processing in which the model learning devices update an aggregate model by machine learning using local learning data to obtain the information for identifying the worker models and provide confidential information of the information for identifying the worker models to the secure federated learning device,
a local processing time is a time corresponding to the local processing,
secure aggregation processing is processing in which the secure federated learning device obtains the confidential information of the information for identifying the new aggregate model obtained by aggregating the plurality of worker models through secure computation using the acquired confidential information of the information for identifying the worker models without obtaining the worker models, and provides the information for identifying the new aggregate model or the confidential information of the information for identifying the new aggregate model to the plurality of model learning devices,
an aggregation processing time is a time corresponding to the secure aggregation processing, and
the acquisition step comprises:
performing asynchronous acquisition processing for obtaining the confidential information of the information for identifying the worker models obtained through asynchronous local processing of the plurality of model learning devices in a case in which the local processing time is longer than the aggregation processing time or the local processing time is equal to or longer than the aggregation processing time; and
performing synchronous acquisition processing for obtaining the confidential information of the information for identifying the worker models obtained through synchronized local processing of the plurality of model learning devices in a case in which the asynchronous acquisition processing is not performed.

9. A non-transitory computer-readable recording medium storing a program for causing a computer to function as the control device according to claim 1.

10. A non-transitory computer-readable recording medium storing a program for causing a computer to function as the model learning device according to claim 4.

11. A non-transitory computer-readable recording medium storing a program for causing a computer to function as the secure federated learning device according to claim 5.
